(19) United States
(12) Patent Application Publication
(10) Pub. No.: US 2025/0074586 A1
(43) Pub. Date: Mar. 6, 2025

(54) RESTRUCTURABLE HYBRID-WING VERTICAL TAKE-OFF AND LANDING AIRCRAFT

(71) Applicant: ZHEJIANG TIANJI BOTTE INTELLIGENT TECHNOLOGY CO., HUZHOU, ZHEJIANG (CN)

(72) Inventors: YU-LIN ZHANG, HUZHOU, ZHEJIANG (CN); LI FAN, HUZHOU, ZHEJIANG (CN); JUN-HUA XIANG, HUZHOU, ZHEJIANG (CN); YUN-HAN HE, HUZHOU, ZHEJIANG (CN); GUANG-WEI WEN, HUZHOU, ZHEJIANG (CN); WEI QIU, HUZHOU, ZHEJIANG (CN)

(21) Appl. No.: 18/563,497

(22) PCT Filed: Oct. 25, 2022
(86) PCT No.: PCT/CN2022/127365

§ 371 Date: Nov. 22, 2023

(30) Foreign Application Priority Data
Sep. 27, 2022 (CN) 202211184614.0

(51) Int. Cl. B64C 29/02; B64C 3/56; B64C 39/12

(52) U.S. Cl. CPC B64C 29/02; B64C 3/56; B64C 39/12

(57) ABSTRACT

A restructurable hybrid-wing VTOL aircraft includes a fuselage, two wings, two canard wings and a cabin door. The two wings are provided to opposite sides of the fuselage. Each the wing is provided vertically and symmetrically by two rotary wing modules, and thus an H configuration to the fuselage can be formed. While the lower rotary wing module rotates to align the corresponding wing, a change of relative position with respect to the upper rotary wing module can be generated. Through the rotation of the lower rotary wing module, the vertical surface thereof would be transformed into a lift surface for enlarging the aspect ratio of the wing to improve the corresponding lift-drag ratio. Thereupon, a disadvantage of hyper flight-directional stability to the H-configured tail seat-type aircraft caused by the vertical area of the aircraft can be reduced, and so the tail-seat type aircraft can slide to emergency land.

### TECHNICAL FIELD

The present disclosure relates in general to an aircraft technology, and more particularly to a VTOL (Vertical take-off and landing) aircraft with an H configuration and rotary wings.

### BACKGROUND

With continuous development of technology, manned aircraft have been widely developed and applied in military and civilian fields around the world. Common manned aircraft mainly include fixed wing aircraft and rotary wing aircraft. The fixed wing aircraft have a longer flying range and are faster, while the rotary wing aircraft present flexibility, stability and controllability in take-off and landing. Recently, VTOL fixed wing aircraft that mix fixed wings and rotary wings have appeared one after another.

Due to a larger wing span of the existing VTOL fixed wing aircraft, the space needed for transportation, takeoff or landing is usually larger. In the process of adjusting the attitude of the existing VTOL fixed wing aircraft to achieve a vertical-to-horizontal flight, the method of changing the relative thrust direction or using two sets of propulsion systems is usually applied, which results in high system complexity, redundant weight, reduced reliability in tilting mechanisms and other hidden dangers. Practically, as long as the existing VTOL aircraft meets an engine failure, the a safe emergency landing trial would be a problem.

### SUMMARY

An object of the present disclosure is to provide a restructurable hybrid-wing vertical take-off and landing (VTOL) aircraft, who is a foldable VTOL tail seat type aircraft furnished with mechanisms for whole-body tilting. Thereupon, problems of the existing VTOL fixed wing aircraft during transportation, landing or take-off in limited space, complicate rotary structures, emergency landing and so on would be substantially resolved,

The technical arrangements according to this disclosure are described as follows:

A restructurable hybrid-wing vertical take-off and landing (VTOL) aircraft, as a tail seat type aircraft, includes a fuselage, wings, canard wings and a cabin door. The fuselage is furnished with the opposite wings to corresponding sides thereof, and a pair of the wings to individual sides thereof, a pair of the horizontal canard wing to opposite sides of a front portion thereof, and a cabin door thereof. At each side of the fuselage, 2 rotary wing modules are provided to the wing vertically and symmetrically with respect to the wing. With each of the two opposite sides of the fuselage being symmetrically furnished with an upper rotary wing module and a lower rotary wing module, a pattern of the H configuration to the fuselage can be formed.

The rotary wing module includes a mounting frame, a power column and a propeller. A bottom of the mounting frame is fixed onto the wing surface. The power column, installed at a top portion of the mounting frame, has a central axis parallel to a central axis of the fuselage. The propeller, mounted in front of the power column, includes a drive device to be installed inside the power column. The power column has an end thereof extending out of the tail. In addition, all the ends of the power columns are arranged to be on the same vertical plane so as to have four said ends of the corresponding power columns to form a four-leg tail base as a landing support of the aircraft. Furthermore, the end of the power column is furnished with a shock absorbing device.

The drive device, for matching any kind of the electric motor or the internal combustion engine, is installed inside the power column. Each of the drive device is connected with a rotary wing module for providing drive forcing.

While the aircraft takes off, lands or flies, the rotary wing module disposed under the wing would rotate (for example, to pivotally rotate) so as to change the relative position with respect to the rotary wing module disposed above the wing. For example, the rotary wing module disposed under the wing would be rotated to a position right under the rotary wing module disposed above the corresponding wing (i.e., forming the H configuration), or to a position parallel to the wing (i.e., outside the corresponding upper rotary wing module).

Practically, while in taking off or landing, the lower rotary wing module of the corresponding wing would be bent to a position right under the upper rotary wing module. Thereupon, four lower rotary wing modules would form the aforesaid H configuration disposed across the corresponding wing. While the aircraft flies horizontally in the sky, the two rotary wing modules located under the corresponding wings would rotate to expand, and thus these two rotary wing modules would form as the opposite wing tips. Thereupon, the propeller of the wing tip is thus provided to boost the corresponding wing. At this time, the propeller of the upper rotary wing module can be restored, and the aircraft is propelled only by the propeller at the wing tip of the lower rotary wing module.

Further, a rotary mechanism is also included to be disposed between the wing and a mounting frame under the wing to rotate the corresponding lower rotary wing module. The aircraft further includes a control system and a power system.

Further, the control system is connected individually with the drive devices of the corresponding rotary wing modules for adjusting the rotary power of each the rotary wing module so as to fulfill the control upon the flight attitude.

Further, the power system, installed inside the fuselage to connect individually the drive devices, is to energize these four rotary wing modules.

Further, the power system includes batteries, a battery management module and electrical equipment to connect individually electrical ends of the corresponding derive devices for power supply. The batteries can be traditional batteries or fuel cells.

Further, the front canard wing of the fuselage can improve the flight attitude, and provide substantially up-lifting forcing. The canard wing is furnished thereon an adjustable control surface, and the control surface can be tilt to adjust the aircraft attitude.

In this disclosure, four rotary wing modules are used to provide power for the aircraft to take off. While the aircraft is to land or lands, these four rotary wing modules would form the H configuration to have the four tail shock absorbing device to touch ground. While the aircraft takes off, these four rotary wing modules would provide the power to lift vertically up the aircraft, without a need of runways. In this disclosure, in comparison with the typical fixed wing aircraft, this aircraft is furnished with shorter wings to less occupy the space. While the aircraft is flying, the control system would adjust individual rotary powers of the corresponding devices to fulfill necessary change of the flight attitude; for example, by tilting gradually the fuselage till the wings can reach a horizontal flight state similar to a fixed-wing aircraft can do. Then, the propellers of the two upper rotary wing modules would be stopped and restored, and the two lower rotary wing modules would rotate to a horizontal surface parallel to the main wings, such that the lower rotary wing module can be structured as a fixed extension wing of the corresponding main wing. Since the aircraft of this disclosure adopts a single propulsion system with low redundancy and enlarged aspect ratio, thus the induced resistance of the aircraft can be reduced, the lift-drag ratio thereof can be increased, and the energy utilization rate thereof can be raised. Thereupon, the vertical area of the aircraft can be reduced, and thus the disadvantage caused by hyper flight-directional stability to the H-configured aircraft would be lessened. As long as the engine hits an emergency situation, the aircraft can still slide stably to land safely through the structured fixed wings. In addition, the envelope volume of the H-configured aircraft can be also reduced.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic perspective view of a preferred embodiment of the restructurable hybrid-wing vertical take-off and landing (VTOL) aircraft in a still state on the ground in accordance with this disclosure;

FIG. 2 is a schematic side view of the preferred embodiment of FIG. 1 in a state of a vertical flight;

FIG. 3 is a schematic top view of FIG. 2;

FIG. 4 is another view of FIG. 3 showing that different expansion states of the lower rotary wing module;

FIG. 5 is a schematic front view of the preferred embodiment of FIG. 1 in a state of a horizontal flight; and

FIG. 6 is a schematic side view of FIG. 5.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

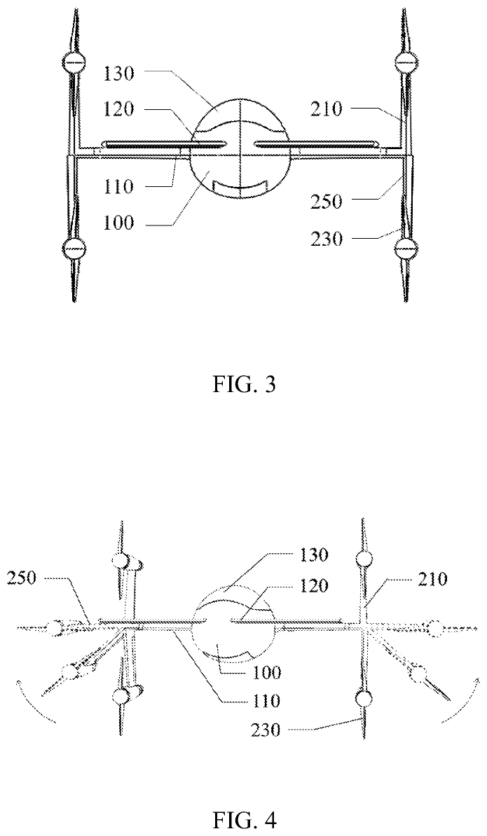

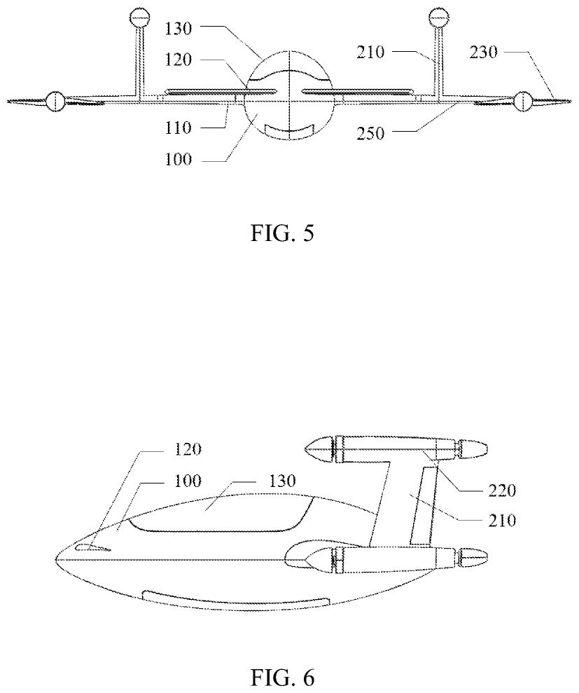

Referring to FIG. 1 to FIG. 6, a tail-seat type aircraft, applied to fulfill the VTOL flight through the entire tilt and rotation, includes a fuselage 100, four rotary wing modules, a control system, a cabin and a power system. The fuselage 100 is furnished with two wings 110 disposed to opposite sides of the fuselage 100. At opposite sides of a front portion of the fuselage 100, a pair of horizontal canard wings 120 are provided. Each of the canard wings has an adjustable control surface to be tilted or rotated for adjusting the aircraft attitude, such that the problem in tilting the control surface can be well resolved.

The fuselage 100 is furnished with a cabin door 130. At the upper and lower sides of each wing 110, two rotary wing modules are provided symmetrically. The upper rotary wing module located above the corresponding wing 110 is fixed vertically to the wing, and the lower rotary wing module located under the wing 110 is connected with a rotary mechanism (not shown in the figure).

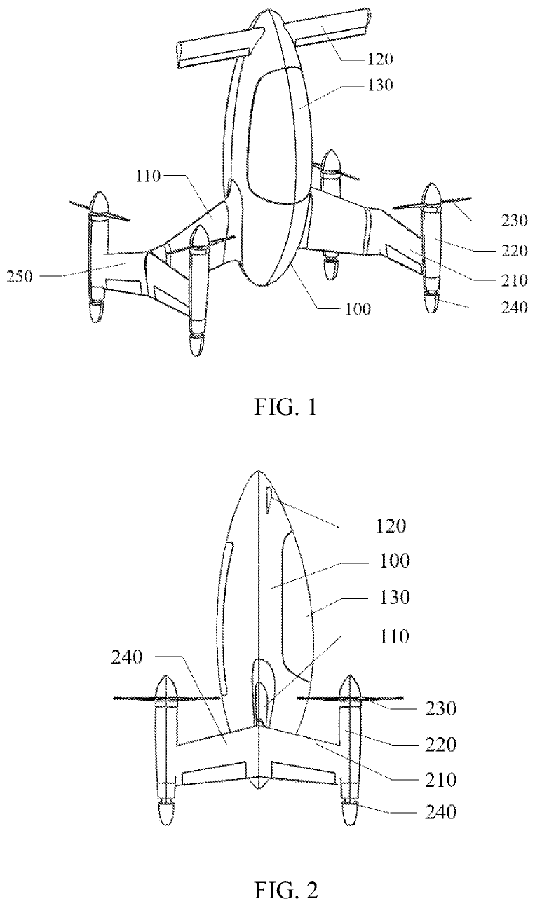

Referring to FIG. 1, FIG. 2 and FIG. 4, each of the rotary wing modules includes two mounting frames (including an upper mounting frame 210 and a lower mounting frame 250), a power column 220 and a propeller 230. A bottom of the upper mounting frame 210 of the upper rotary wing module is fixed to the wing 110. The rotary mechanism, disposed between the lower mounting frame 250 and the wing 110 for driving the lower mounting frame 250 to rotate. The power column 220, disposed to each of the upper mounting frame 210 and the lower mounting frame 250, is parallel to a central axis of the fuselage 100. The propeller 230 is mounted to a front end of the power column 220, while the electrical devices of the propeller 230 are built in the power column 220. The propellers are driven by electrical motors. Each of the motors is connected with one propeller for providing drive forcing. The control system connects all four motors to adjust individual rotary powers for fulfilling changes in flight attitude. The power system, installed inside the fuselage 100, connects all four source ends of the corresponding motors so as to provide the necessary powers. In this disclosure, the power system includes batteries, battery management module and electricity equipment.

Referring to FIG. 2 to FIG. 6, while the aircraft is in the process of vertically taking off or landing, the fuselage 100 is posed upward, with four rotary wing modules to present the H configuration across the wing 110. After the aircraft turns to fly horizontally, the lower mounting frame 250 gradually expands to a horizontal position so as to integrate the wing 110 to form an elongated fixed wing. Simultaneously, the two propellers 230 of the two rotary wing modules above the wing 110 would be restored. Thus, only the rotary wing modules forming the wing tips of the elongated fixed wings are used to provide power.

While in landing, referring to FIG. 1 and FIG. 2, ends of the four power columns 220 would be extended out of the tail, and fall on the same vertical surface which is treated as landing supports. The end of the power column 220 is furnished with a shock absorbing device 240 for the aircraft to land stably.

Generally, the tail-seat type aircraft needs a plurality of supportive mechanisms. Such a supportive mechanism is actually a resistance surface against a horizontal flight. In this embodiment, the aircraft adopts the rotary mechanism to transform the supportive mechanism (i.e., the lower rotary wing module) from a resistance surface into a lift surface, such that the aspect ratio of the wing would increase the lift-drag ratio.

The rotary mechanism turns the vertical stabilizer of the lower rotary wing module into s lift surface, such that the wing area of the aircraft in the horizontal flight can be enlarged, the disadvantage caused by hyper flight-directional stability to the H-configured tail seat-type aircraft can be reduced, and also the lift-drag ratio can be increased.

To the tail-seat type aircraft, the propulsion system is asked to be symmetrically distributed with respect to a center of gravity. Any stop occurred to an engine would unbalance the thrust with respect to the center of gravity. Since the tail-seat type aircraft requires far more power in vertically taking off or landing than horizontally flight, thus part of the engines of this disclosure will meet frequently stops during the flight. According to the specific structuring of the aircraft in this embodiment, the propulsion system may keep better symmetrical power distribution with respect to the center of gravity while in meeting stops of individual propulsion mechanisms.

In addition, the rotary mechanism of this disclosure also allows the tail-seat type aircraft to be capable of normal taking off or landing (i.e., in a horizontal manner). Thereupon, the tail-seat type aircraft of this disclosure can also slide to emergency land while in meeting any failure at the propulsion system, and so the safety of the tail-seat type aircraft can be greatly ensured.

According to this disclosure, the rotary aircraft does resolve some shortcomings of the existing fixed-wing aircraft in storage, transportation and space requirements in taking off or landing.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A restructurable hybrid-wing vertical take-off and landing (VTOL) aircraft, including a fuselage, two wings, two canard wings and a cabin door, the two wings being provided to opposite sides of the fuselage, characterized in that: the aircraft includes four rotary wing modules, and each of the four rotary wing modules includes mounting frames, a power column and a propeller;
wherein one of the two wings at one side of the fuselage is provided vertically and symmetrically by two of the four rotary wing modules, another one of the two wings at another side of the fuselage is provided vertically and symmetrically by another two of the four rotary wing modules, and thus an H configuration to the fuselage is formed;
wherein the rotary wing module located under the corresponding wing rotates to generate a change of relative position with respect to the rotary wing module located above the same wing.

2. The restructurable hybrid-wing vertical take-off and landing (VTOL) aircraft of claim 1, wherein ends of the four power columns are extended out of a tail of the aircraft to form a four-foot tail seat on the same vertical surface as a support for grounding the aircraft.

3. The restructurable hybrid-wing vertical take-off and landing (VTOL) aircraft of claim 1, wherein the end of the power column is furnished with a shock absorbing device.

4. The restructurable hybrid-wing vertical take-off and landing (VTOL) aircraft of claim 1, further including a rotary mechanism disposed between the wing and the rotary wing module located under this wing, for rotating the rotary wing module located under this wing.

5. The restructurable hybrid-wing vertical take-off and landing (VTOL) aircraft of claim 1, wherein, while the aircraft is in taking off or landing, the rotary wing module located under the wing is located right under the corresponding rotary wing module located above the wing so as to have these four rotary wing modules to form the H configuration.

6. The restructurable hybrid-wing vertical take-off and landing (VTOL) aircraft of claim 1, wherein, while the aircraft flies horizontally in the sky, the rotary wing module located under this wing is rotated to expand so as to restructure this rotary wing module as a wing tip to the corresponding wing.

7. The restructurable hybrid-wing vertical take-off and landing (VTOL) aircraft of claim 1, further including a control system and a power system.

8. The restructurable hybrid-wing vertical take-off and landing (VTOL) aircraft of claim 7, wherein the control system is connected individually to drive devices of the corresponding rotary wing modules so as to adjust rotary powers of the corresponding rotary wing modules for fulfilling control of flight attitude.

9. The restructurable hybrid-wing vertical take-off and landing (VTOL) aircraft of claim 7, wherein the power system is configured inside the fuselage to connect individually the drive devices for energizing the four rotary wing modules.

10. The restructurable hybrid-wing vertical take-off and landing (VTOL) aircraft of claim 1, wherein a front portion of the fuselage is further furnished oppositely with a pair of horizontal canard wings, and each of the canard wings has an adjustable control surface; wherein the adjustable control surface is tilted to adjust the aircraft attitude.
